(19) United States
(12) Patent Application Publication
(10) Pub. No.: US 2012/0090648 A1
(43) Pub. Date: Apr. 19, 2012

(54) CLEANING METHOD FOR SEMICONDUCTOR WAFER AND CLEANING DEVICE FOR SEMICONDUCTOR WAFER

(75) Inventor: An-Chi LIU, Tainan City (TW)

(73) Assignee: UNITED MICROELECTRONICS CORP., HSINCHU (TW)

(21) Appl. No.: 12/905,763

(22) Filed: Oct. 15, 2010

(51) Int. Cl. B08B 3/00

(52) U.S. Cl. 134/33; 134/157

(57) ABSTRACT

A cleaning method of a semiconductor wafer includes the following steps. A semiconductor wafer is provided. A cleaning solution is sprayed to the semiconductor wafer. The semiconductor wafer is driven to spin along a first direction for a first time. The semiconductor wafer is driven to spin along a second direction for a second time. The cleaning method can effectively clean the semiconductor wafer. A cleaning device for cleaning a semiconductor wafer is also provided.

### FIELD OF THE INVENTION

The present invention relates to a semiconductor fabrication, and particularly to a cleaning method for a semiconductor wafer and a cleaning device for a semiconductor wafer.

### BACKGROUND OF THE INVENTION

Multi-level interconnection technology has been widely applied in integrated circuits (ICs). A conventional method for fabricating a multi-level interconnection includes dry etching a metallic layer to form a number of metallic traces and filling a dielectric layer into a number of gaps between the metallic traces. A damascene method for fabricating the multi-level interconnection is a newly developed. In the damascene method, at first, a number of grooves are formed in a dielectric layer. Then, a metallic material is filled in the grooves to form a number of metallic traces. The damascene method can form the metallic traces without etching the metallic layer. Because it is not easy to etch the metallic layer, for example, a copper layer, the damascene method is very important to form the multi-level interconnection by the copper layer.

FIGS. 1(a)-1(d) illustrate a process flow of a dual damascene process using a hard mask. Referring to FIG. 1(a), a structure before the dual damascene etch step of the dual damascene process is shown. An etch stop layer 11 is formed on a copper traces 10. A low-k dielectric layer 12 is formed on the etch stop layer 11. A buffer layer 13 is formed on the low-k dielectric layer 12. A hard mask 14 is formed on the buffer layer 13. A photoresist 15 is formed on the hard mask 14. The hard mask 14 and the photoresist 15 are patterned. A material of the hard mask 14 is titanium nitride (TiN). Next, Referring to FIGS. 1(b), 1(c), and 1(d), a dry etching process is performed. In FIG. 1(b), the dry etching process is performed through a number of openings (not labeled) in the photoresist 15 and the hard mask 14. Thus, the portions of the low-k dielectric layer 12 and the buffer layer 13 are removed to form a number of vias 120. In FIG. 1(c), the dry etching process is continued for an enough time to etch the photoresist 15, the hard mask 14 and the etch stop layer 11 till the photoresist 15 is removed to expose the hard mask 14 and the buffer layer 13. In FIG. 1(d), the dry etching process is still continued till the etch stop layer 11 is removed to expose the copper traces 10. A portion 121 of the low-k dielectric layer 12 only has a buffer layer 13 thereon, but has not the hard mask 14 on the buffer layer 13. Thus, after etching, a protruding structure 122 is formed. A height of the protruding structure 122 is less than the height of the low-k dielectric layer 12. As a result, a dual damascene groove structure 16 is finished.

However, referring to FIG. 2, in the above dual damascene process using a hard mask, a byproduct such 20 as polymer is prone to generate at the bottom of the vias 120 and to deposit on the copper traces 10. Thus, the filled copper layer 21 can not be effectively contacted with the copper traces 10 due to the byproduct 20 on the copper traces 10.

Therefore, after the dual damascene groove structure 16 is finished, a cleaning process is conventionally performed. Referring to FIG. 3, a spin clean tool is applied to clean the dual damascene groove structure 16 to remove the byproduct. A nozzle 31 faces to a center of a wafer 30 and sprays a chemical cleaning solution. The wafer 30 is put on a spinning device 32 and is driven by the spinning device 32 to spin along an identical direction at a changeless spinning speed. The chemical cleaning solution cleans a surface of the wafer 30 through a centrifugal force. However, it is a trend to reduce the sizes of the components. The conventional cleaning process can not effectively remove the byproduct, thereby increasing possibility of forming the bad dies on the wafer.

Therefore, what is needed is a cleaning method for a semiconductor wafer and a cleaning device for a semiconductor wafer to overcome the above disadvantages.

### SUMMARY OF THE INVENTION

The present invention provides a cleaning method for a semiconductor wafer so as to effectively clean the semiconductor wafer.

The present invention provides a cleaning method for a semiconductor wafer so as to effectively clean the semiconductor wafer.

The present invention provides a cleaning method of a semiconductor wafer, which includes the following steps. A semiconductor wafer is provided. A cleaning solution is sprayed to the semiconductor wafer. The semiconductor wafer is driven to spin along a first direction for a first time. The semiconductor wafer is driven to spin along a second direction for a second time.

In one embodiment of the present invention, the semiconductor wafer comprises a dual damascene groove structure.

In one embodiment of the present invention, the cleaning solution is a chemical cleaning solution.

In one embodiment of the present invention, the chemical solution is either an organic acid or an inorganic acid.

In one embodiment of the present invention, the first direction is a clockwise direction and the second direction is an anti-clockwise direction, or the first direction is an anti-clockwise direction and the second direction is a clockwise direction.

The present invention also provides a cleaning device for cleaning a semiconductor wafer. The cleaning device includes a nozzle and a spinning device. The nozzle is configured for spraying a cleaning solution to the semiconductor wafer. The spinning device is configured for supporting the semiconductor wafer and driving the semiconductor wafer to spin along a first direction for a first time and driving the semiconductor wafer to spin along a second direction for a second time after rotating along the first direction for the first time.

### BRIEF DESCRIPTION OF THE DRAWINGS

The above objects and advantages of the present invention will become more readily apparent to those ordinarily skilled in the art after reviewing the following detailed description and accompanying drawings, in which:

FIGS. 1(a)-1(d) illustrate a process flow of a dual damascene process using a hard mask.

FIG. 2 illustrates a schematic view of a dual damascene groove structure with a byproduct.

FIG. 3 illustrates a schematic view of a spin clean tool applied to clean a dual damascene groove structure.

FIGS. 4(a)-4(b) illustrate a schematic view of a cleaning method for a semiconductor wafer in accordance with an embodiment of the present invention.

FIG. 5 illustrates a flow chart of a method for controlling a spinning device in accordance with an embodiment of the present invention.

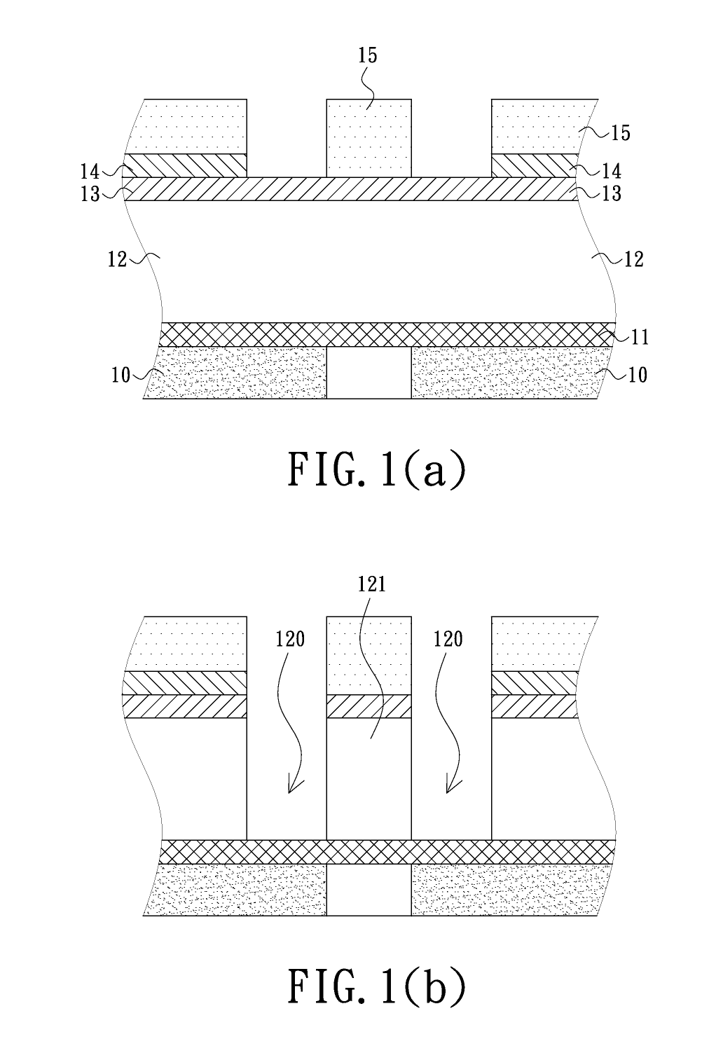

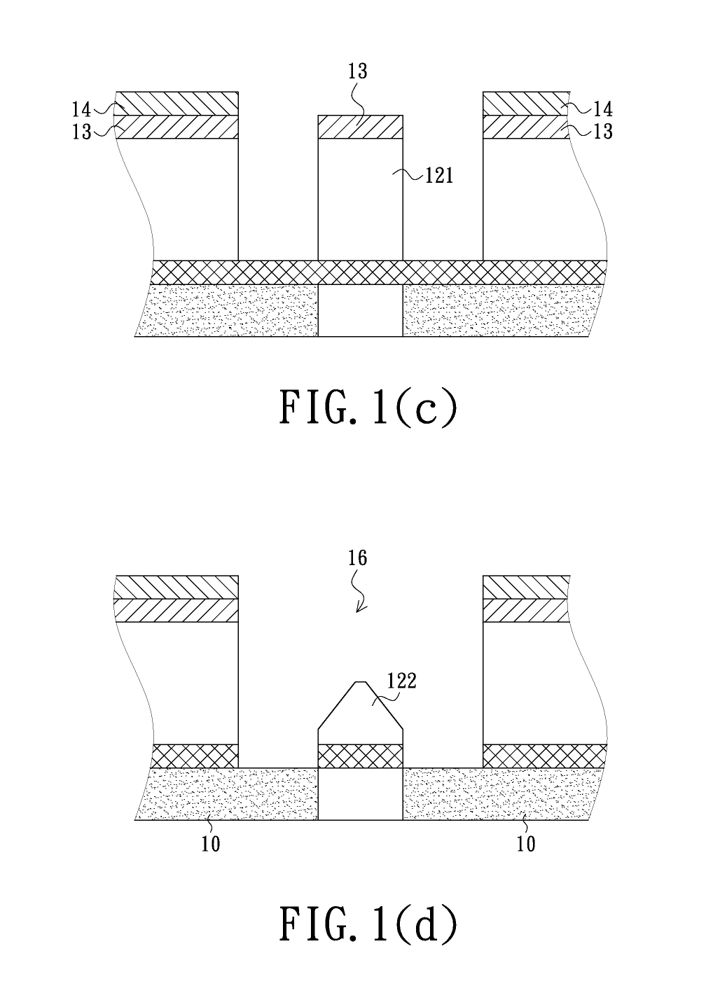

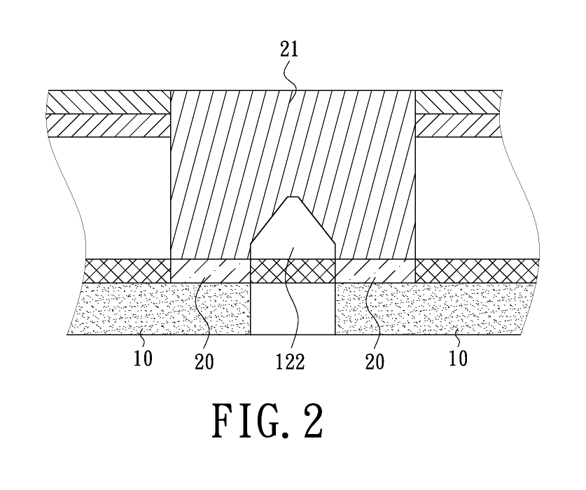

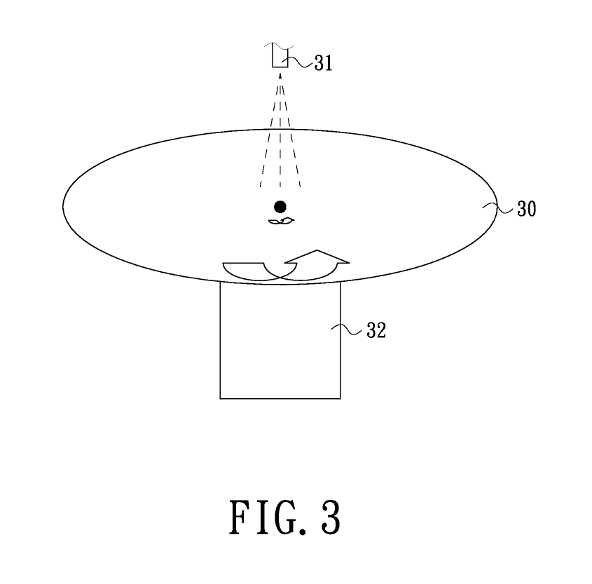

### DETAILED DESCRIPTION OF PREFERRED EMBODIMENTS

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

According the distribution of the bad dies on the wafer cleaning by the conventional cleaning process, it is found that a number of the bad dies on the center of the wafer is far greater than a number of the bad dies on the edge of the wafer. On a condition of the same rotation speed, a tangent speed of the center of the wafer is far lower than a tangent speed of the edge of the wafer. Thus, due to the essential reason of the lower tangent speed of the center of the wafer, the chemical cleaning solution can not effectively clean the center of the wafer so that the byproduct in the grooves of the dies on the center of the wafer can not be removed effectively.

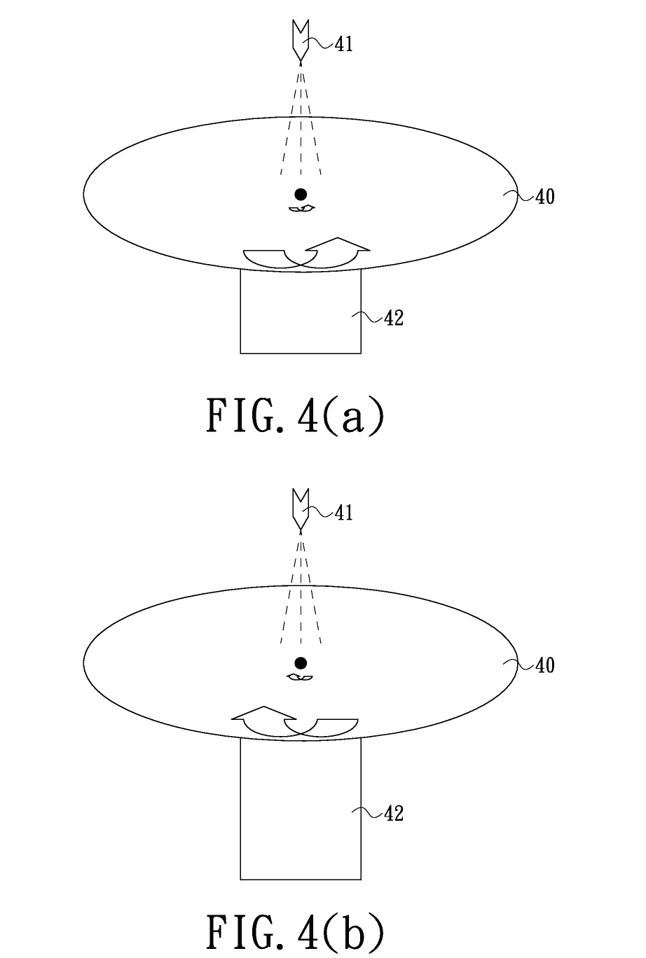

FIGS. 4(a)-4(b) illustrate a schematic view of a cleaning method for a semiconductor wafer in accordance with an embodiment of the present invention. The cleaning method is also applied to cleaning a semiconductor wafer including a dual damascene groove structure. That is, after the dual damascene groove structure is finished, the cleaning method is performed. Referring to FIG. 4(a), a nozzle 41 faces to a center of a semiconductor wafer 40 and sprays a chemical cleaning solution. The semiconductor wafer 40 is driven by a spinning device 42 to spin along a first direction at a changeless rotation speed. In the present embodiment, the first direction is an anti-clockwise direction as shown in FIG. 4(a). In order to improve clean of the center of the semiconductor wafer 40, after the semiconductor wafer 40 is driven to spin along the first direction for a first time, the nozzle 41 continually sprays the chemical cleaning solution and the semiconductor wafer 40 is driven by the spinning device 42 to spin along a second direction at the changeless rotation speed for a second time. In the present embodiment, the second direction is a clockwise direction as shown in FIG. 4(b). It is noted that the semiconductor wafer 40 can be driven to spin along the first direction and the second direction alternately for many times. Because the semiconductor wafer 40 is driven to spin along different directions, a displacement of the chemical cleaning solution at the center of the semiconductor wafer 40 can be increased, thereby improving the cleaning effect. The chemical cleaning solution can be either an organic acid or an inorganic acid.

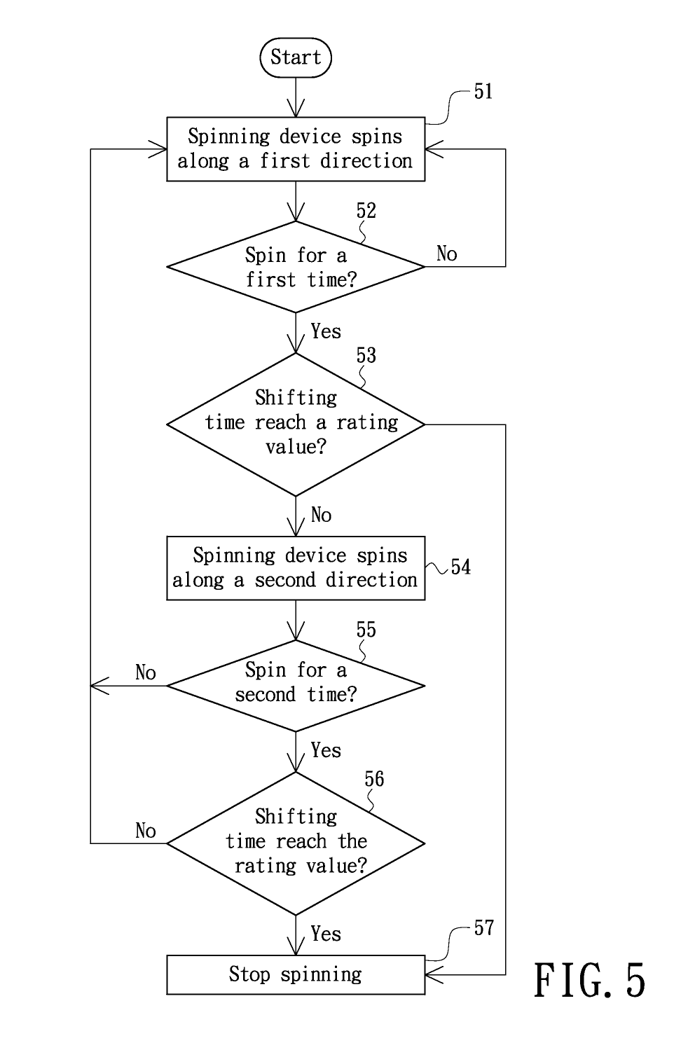

FIG. 5 illustrates a flow chart of a method for controlling a spinning device 42 in accordance with an embodiment of the present invention. Referring to FIG. 5, at first, the spinning device 42 is spun along a first direction (step 51). Next, whether the spinning device 42 is spun for the first time is judged (step 52). If the spinning device 42 is not spun for the first time, the spinning device 42 is still spun along the first direction (back to the step 51). If the spinning device 42 is spun for the first time, whether a shifting time is a rating value is judged (step 53). Next, if the shifting time is equal to the rating value, the spinning device 42 stops spinning (step 57). If the shifting time is not equal to the rating value, the spinning device 42 is changed to spin along a second direction (step 54). Next, whether the spinning device 42 is spun for the second time is judged (step 55). If the spinning device 42 is spun for the second time, the spinning device 42 is still spun along the second direction (back to the step 54). If the spinning device 42 is spun for the second time, whether a shifting time is the rating value is judged (step 56). If the shifting time is equal to a rating value, the spinning device 42 stops spinning (step 57). If the shifting time is not equal to a rating value, the spinning device 42 is changed to spin along the first direction again (back to step 51).

For example, in the conventional cleaning process, the semiconductor wafer 40 is driven to spin along an identical direction at a changeless spinning speed (e.g., 300-500 rpm) for 15 seconds. In the cleaning method of the present embodiment, the first time and the second time are respectively 5 seconds, and the rating value is 2 times. Thus, the semiconductor wafer 40 is driven to spin along a clockwise direction and an-anti clockwise direction alternately at a changeless spinning speed (e.g., 300-500 rpm). In detail, the semiconductor wafer 40 is driven to spin along the clockwise direction for 5 seconds and then is driven to spin along the anti-clockwise direction for 5 seconds. The semiconductor wafer 40 is driven to spin for three times. For example, the semiconductor wafer 40 is driven to spin along the clockwise direction, the anti-clockwise direction, and clockwise direction alternately. For another example, the semiconductor wafer 40 is driven to spin along the anti-clockwise direction, the clockwise direction, and anti-clockwise direction alternately. The total spinning time is also 15 seconds. As a result, a yield of the dies at the center of the semiconductor wafer fabricated by a 45 nanometers process is increased from 90.32% to 96.77%, thereby reducing possibility of forming the bad dies on the semiconductor wafer.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A cleaning method of a semiconductor wafer, comprising:
providing a semiconductor wafer;
spraying a cleaning solution to the semiconductor wafer;
driving the semiconductor wafer to spin along a first direction for a first time; and
driving the semiconductor wafer to spin along a second direction for a second time.

2. The cleaning method of the semiconductor wafer as claimed in claim 1, wherein the semiconductor wafer comprises a dual damascene groove structure.

3. The cleaning method of the semiconductor wafer as claimed in claim 2, wherein the cleaning solution is a chemical cleaning solution and is configured for removing a byproduct in a dry process of forming the dual damascene groove structure.

4. The cleaning method of the semiconductor wafer as claimed in claim 3, wherein the chemical solution is either an organic acid or an inorganic acid.

5. The cleaning method of the semiconductor wafer as claimed in claim 1, wherein either the first direction is a clockwise direction and the second direction is an anti-clockwise direction or the first direction is an anti-clockwise direction and the second direction is a clockwise direction.

6. A cleaning device for cleaning a semiconductor wafer, the cleaning device comprising:
a nozzle for spraying a cleaning solution to the semiconductor wafer;
a spinning device for supporting the semiconductor wafer and driving the semiconductor wafer to spin along a first direction for a first time and driving the semiconductor wafer to spin along a second direction for a second time after rotating along the first direction for the first time.

7. The cleaning device as claimed in claim 6, wherein the semiconductor wafer comprises a dual damascene groove structure.

8. The cleaning device as claimed in claim 7, wherein the cleaning solution is a chemical cleaning solution and is configured for removing a byproduct in a dry process of forming the dual damascene groove structure.

9. The cleaning device as claimed in claim 8, wherein the chemical solution is either an organic acid or an inorganic acid.

10. The cleaning device as claimed in claim 6, wherein either the first direction is a clockwise direction and the second direction is an anti-clockwise direction or the first direction is an anti-clockwise direction and the second direction is a clockwise direction.
